(19) United States
(12) Patent Application Publication
(10) Pub. No.: US 2016/0005179 A1
(43) Pub. Date: Jan. 7, 2016

(54) METHODS AND APPARATUS FOR MERGING DEPTH IMAGES GENERATED USING DISTINCT DEPTH IMAGING TECHNIQUES

(71) Applicant: LSI CORPORATION, San Jose, CA (US)

(72) Inventors: Alexander A. Petyushko, Moscow (RU); Denis V. Parfenov, Moscow (RU); Ivan L. Mazurenko, Moscow (RU); Alexander B. Kholodenko, Moscow (RU)

(21) Appl. No.: 14/233,943

(22) PCT Filed: Aug. 23, 2013
(86) PCT No.: PCT/US2013/056397

§ 371 Date: Jan. 21, 2014

(30) Foreign Application Priority Data
Dec. 17, 2012 (RU) 2012154657

(51) Int. Cl. G06T 7/00; H04N 13/02

(52) U.S. Cl. CPC G06T 7/0065; G06T 7/0055; H04N 13/025; H04N 13/0271; G06T 2207/10028; G06T 2207/20228

(57) ABSTRACT

A depth imager is configured to generate a first depth image using a first depth imaging technique, and to generate a second depth image using a second depth imaging technique different than the first depth imaging technique. At least portions of the first and second depth images are merged to form a third depth image. The depth imager comprises at least one sensor including a single common sensor at least partially shared by the first and second depth imaging techniques, such that the first and second depth images are both generated at least in part using data acquired from the single common sensor. By way of example, the first depth image may comprise a structured light (SL) depth map generated using an SL depth imaging technique, and the second depth image may comprise a time of flight (ToF) depth map generated using a ToF depth imaging technique.

### FIELD

The field relates generally to image processing, and more particularly to processing of depth images.

### BACKGROUND

A number of different techniques are known for generating three-dimensional (3D) images of a spatial scene in real time. For example, 3D images of a spatial scene may be generated using triangulation based on multiple two-dimensional (2D) images captured by respective cameras arranged such that each camera has a different view of the scene. However, a significant drawback of such a technique is that it generally requires very intensive computations, and can therefore consume an excessive amount of the available computational resources of a computer or other processing device. Also, it can be difficult to generate an accurate 3D image under conditions involving insufficient ambient lighting when using such a technique.

Other known techniques include directly generating a 3D image using a depth imager such as a structured light (SL) camera or a time of flight (ToF) camera. Cameras of this type are usually compact, provide rapid image generation, and operate in the near-infrared part of the electromagnetic spectrum. As a result, SL and ToF cameras are commonly used in machine vision applications such as gesture recognition in video gaming systems or other types of image processing systems implementing gesture-based human-machine interfaces. SL and ToF cameras are also utilized in a wide variety of other machine vision applications, including, for example, face detection and singular or multiple person tracking.

SL cameras and ToF cameras operate using different physical principles and as a result exhibit different advantages and drawbacks with regard to depth imaging.

A typical conventional SL camera includes at least one emitter and at least one sensor. The emitter is configured to project designated light patterns onto objects in a scene. The light patterns comprise multiple pattern elements such as lines or spots. The corresponding reflected patterns appear distorted at the sensor because the emitter and the sensor have different perspectives of the objects. A triangulation approach is used to determine an exact geometric reconstruction of object surface shape. However, due to the nature of the light patterns projected by the emitter, it is much easier to establish association between elements of the corresponding reflected light pattern received at the sensor and particular points in the scene, thereby avoiding much of the burdensome computation associated with triangulation using multiple 2D images from different cameras.

Nonetheless, SL cameras have inherent difficulties with precision in x and y dimensions because the light pattern-based triangulation approach does not allow pattern size to be made arbitrarily fine-granulated in order to achieve high resolution. Also, in order to avoid eye injury, both overall emitted power across the entire pattern as well as spatial and angular power density in each pattern element (e.g., a line or a spot) are limited. The resulting image therefore exhibits low signal-to-noise ratio and provides only a limited quality depth map, potentially including numerous depth artifacts.

Although ToF cameras are typically able to determine x-y coordinates more precisely than SL cameras, ToF cameras also have issues with regard to spatial resolution, particularly in terms of depth measurements or z coordinates. Therefore, in conventional practice, ToF cameras generally provide better x-y resolution than SL cameras, while SL cameras generally provide better z resolution than ToF cameras.

Like an SL camera, a typical conventional ToF camera also includes at least one emitter and at least one sensor. However, the emitter is controlled to produce continuous wave (CW) output light having substantially constant amplitude and frequency. Other variants are known, including pulse-based modulation, multi-frequency modulation and coded pulse modulation, and are generally configured to improve depth imaging precision or to reduce mutual interference between multiple cameras, relative to the CW case.

In these and other ToF arrangements, the output light illuminates a scene to be imaged and is scattered or reflected by objects in the scene. The resulting return light is detected by the sensor and utilized to create a depth map or other type of 3D image. The sensor receives light reflected from entire illuminated scene at once and estimates distance to each point by measuring the corresponding time delay. This more particularly involves, for example, utilizing phase differences between the output light and the return light to determine distances to the objects in the scene.

Depth measurements are typically generated in a ToF camera using techniques requiring very fast switching and temporal integration in analog circuitry. For example, each sensor cell may comprise a complex analog integrated semiconductor device, incorporating a photonic sensor with picosecond switches and high-precision integrating capacitors, in order to minimize measurement noise via temporal integration of sensor photocurrent. Although the drawbacks associated with use of triangulation are avoided, the need for complex analog circuitry increases the cost associated with each sensor cell. As a result, the number of sensor cells that can be used in a given practical implementation is limited, which can in turn limit the achievable quality of the depth map, again leading to an image that may include a significant number of depth artifacts.

### SUMMARY

In one embodiment, a depth imager is configured to generate a first depth image using a first depth imaging technique, and to generate a second depth image using a second depth imaging technique different than the first depth imaging technique. At least portions of each of the first and second depth images are merged to form a third depth image. The depth imager comprises at least one sensor including a single common sensor at least partially shared by the first and second depth imaging techniques, such that the first and second depth images are both generated at least in part using data acquired from the single common sensor. By way of example only, the first depth image may comprise an SL depth map generated using an SL depth imaging technique, and the second depth image may comprise a ToF depth map generated using a ToF depth imaging technique.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of an embodiment of an image processing system comprising a depth imager configured with depth map merging functionality.

FIGS. 2 and 3 illustrate exemplary sensors implemented in respective embodiments of the depth imager of FIG. 1.

FIG. 4 shows a portion of a data acquisition module associated with a single cell of a given depth imager sensor and configured to provide a local depth estimate in an embodiment of the depth imager of FIG. 1.

FIG. 5 shows a data acquisition module and an associated depth map processing module configured to provide global depth estimates in an embodiment of the depth imager of FIG. 1.

FIG. 6 illustrates an example of a pixel neighborhood around a given interpolated pixel in an exemplary depth image processed in the depth map processing module of FIG. 5.

### DETAILED DESCRIPTION

Embodiments of the invention will be illustrated herein in conjunction with exemplary image processing systems that include depth imagers configured to generate depth images using respective distinct depth imaging techniques, such as respective SL and ToF depth imaging techniques, with the resulting depth images being merged to form another depth image. For example, embodiments of the invention include depth imaging methods and apparatus that can generate higher quality depth maps or other types of depth images having enhanced depth resolution and fewer depth artifacts than those generated by conventional SL or ToF cameras. It should be understood, however, that embodiments of the invention are more generally applicable to any image processing system or associated depth imager in which it is desirable to provide improved quality for depth maps or other types of depth images.

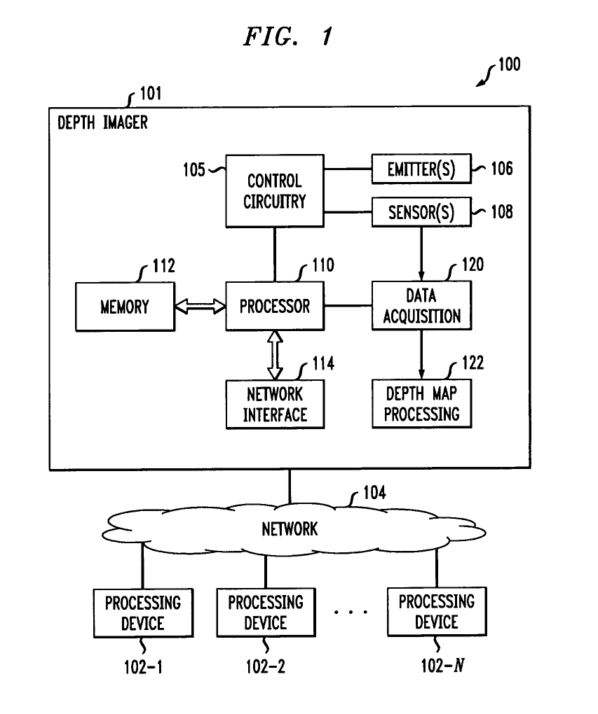

FIG. 1 shows an image processing system 100 in an embodiment of the invention. The image processing system 100 comprises a depth imager 101 that communicates with a plurality of processing devices 102-1, 102-2, . . . 102-N, over a network 104. The depth imager 101 in the present embodiment is assumed to comprise a 3D imager that incorporates multiple distinct types of depth imaging functionality, illustratively both SL depth imaging functionality and ToF depth imaging functionality, although a wide variety of other types of depth imagers may be used in other embodiments.

The depth imager 101 generates depth maps or other depth images of a scene and communicates those images over network 104 to one or more of the processing devices 102. The processing devices 102 may comprise computers, servers or storage devices, in any combination. By way of example, one or more such devices may include display screens or various other types of user interfaces that are utilized to present images generated by the depth imager 101.

Although shown as being separate from the processing devices 102 in the present embodiment, the depth imager 101 may be at least partially combined with one or more of the processing devices. Thus, for example, the depth imager 101 may be implemented at least in part using a given one of the processing devices 102. By way of example, a computer may be configured to incorporate depth imager 101 as a peripheral.

In a given embodiment, the image processing system 100 is implemented as a video gaming system or other type of gesture-based system that generates images in order to recognize user gestures or other user movements. The disclosed imaging techniques can be similarly adapted for use in a wide variety of other systems requiring a gesture-based human-machine interface, and can also be applied to numerous applications other than gesture recognition, such as machine vision systems involving face detection, person tracking or other techniques that process depth images from a depth imager. These are intended to include machine vision systems in robotics and other industrial applications.

The depth imager 101 as shown in FIG. 1 comprises control circuitry 105 coupled to one or more emitters 106 and one or more sensors 108. A given one of the emitters 106 may comprise, for example, a plurality of LEDs arranged in an LED array. Each such LED is an example of what is more generally referred to herein as an “optical source.” Although multiple optical sources are used in an embodiment in which an emitter comprises an LED array, other embodiments may include only a single optical source. Also, it is to be appreciated that optical sources other than LEDs may be used. For example, at least a portion of the LEDs may be replaced with laser diodes or other optical sources in other embodiments. The term “emitter” as used herein is intended to be broadly construed so as to encompass all such arrangements of one or more optical sources.

The control circuitry 105 illustratively comprises one or more driver circuits for each of the optical sources of the emitters 106. Accordingly, each of the optical sources may have an associated driver circuit, or multiple optical sources may share a common driver circuit. Examples of driver circuits suitable for use in embodiments of the present invention are disclosed in U.S. patent application Ser. No. 13/658,153, filed Oct. 23, 2012 and entitled “Optical Source Driver Circuit for Depth Imager,” which is commonly assigned herewith and incorporated by reference herein.

The control circuitry 105 controls the optical sources of the one or more emitters 106 so as to generate output light having particular characteristics. Ramped and stepped examples of output light amplitude and frequency variations that may be provided utilizing a given driver circuit of the control circuitry 105 can be found in the above-cited U.S. patent application Ser. No. 13/658,153.

The driver circuits of control circuitry 105 can therefore be configured to generate driver signals having designated types of amplitude and frequency variations, in a manner that provides significantly improved performance in depth imager 101 relative to conventional depth imagers. For example, such an arrangement may be configured to allow particularly efficient optimization of not only driver signal amplitude and frequency, but also other parameters such as an integration time window.

The output light from the one or more emitters 106 illuminates a scene to be imaged and the resulting return light is detected using one or more sensors 108 and then further processed in control circuitry 105 and other components of depth imager 101 in order to create a depth map or other type of depth image. Such a depth image may illustratively comprise, for example, a 3D image.

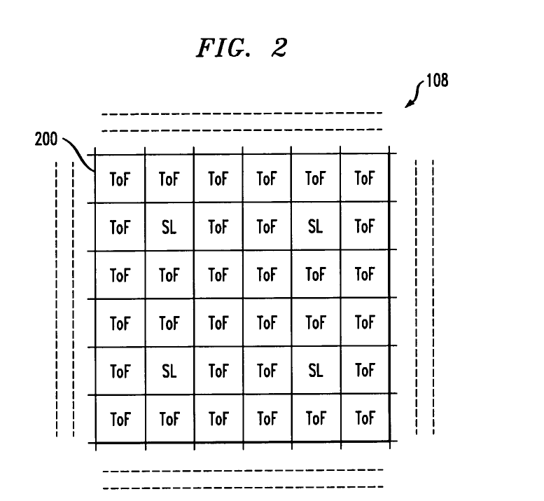

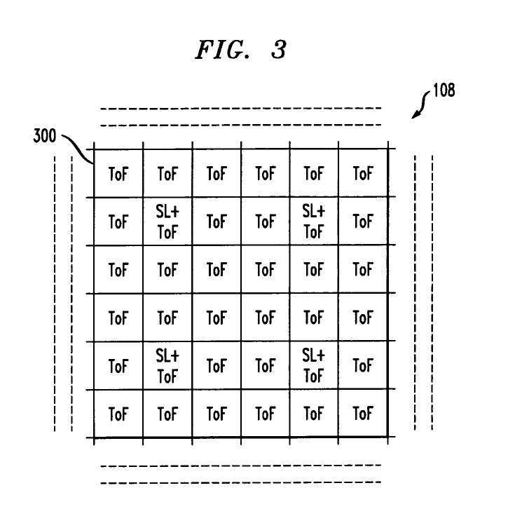

A given sensor 108 may be implemented in the form of a detector array comprising a plurality of sensor cells each including a semiconductor photonic sensor. For example, detector arrays of this type may comprise charge-coupled device (CCD) sensors, photodiode matrices, or other types and arrangements of multiple optical detector elements. Examples of particular arrays of sensor cells will be described below in conjunction with FIGS. 2 and 3.

The depth imager 101 in the present embodiment is assumed to be implemented using at least one processing device and comprises a processor 110 coupled to a memory 112. The processor 110 executes software code stored in the memory 112 in order to direct at least a portion of the operation of the one or more emitters 106 and the one or more sensors 108 via the control circuitry 105. The depth imager 101 also comprises a network interface 114 that supports communication over network 104.

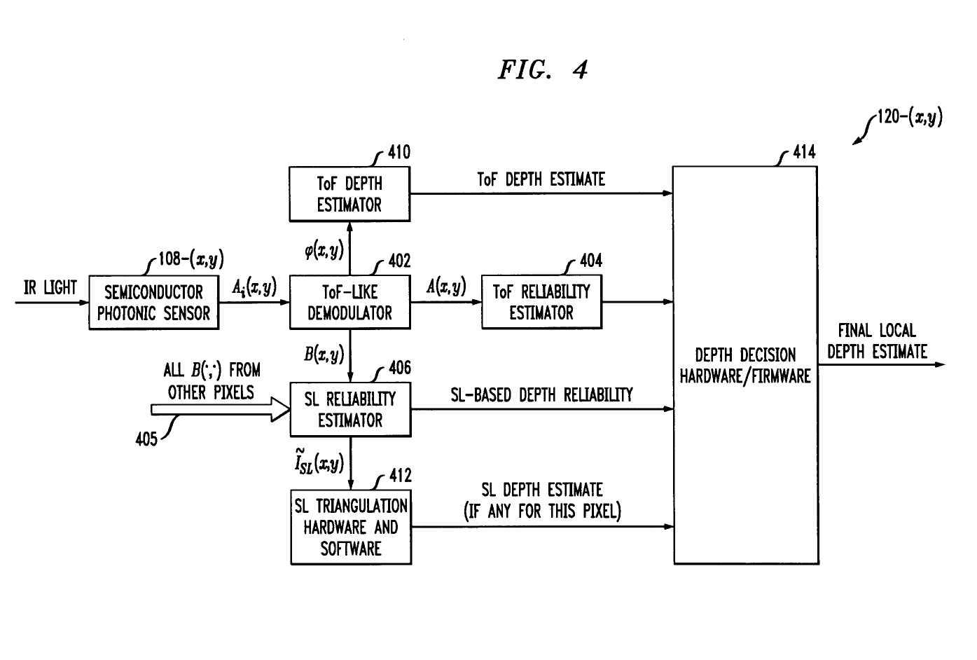

Other components of the depth imager 101 in the present embodiment include a data acquisition module 120 and a depth map processing module 122. Exemplary image processing operations implemented using data acquisition module 120 and depth map processing module 122 of depth imager 101 will be described in greater detail below in conjunction with FIGS. 4 through 6.

The processor 110 of depth imager 101 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 112 stores software code for execution by the processor 110 in implementing portions of the functionality of depth imager 101, such as portions of at least one of the data acquisition module 120 and the depth map processing module 122.

A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination.

As indicated above, the processor 110 may comprise portions or combinations of a microprocessor, ASIC, FPGA, CPU, ALU, DSP or other image processing circuitry, and these components may additionally comprise storage circuitry that is considered to comprise memory as that term is broadly used herein.

It should therefore be appreciated that embodiments of the invention may be implemented in the form of integrated circuits. In a given such integrated circuit implementation, identical die are typically formed in a repeated pattern on a surface of a semiconductor wafer. Each die includes, for example, at least a portion of control circuitry 105 and possibly other image processing circuitry of depth imager 101 as described herein, and may further include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The network 104 may comprise a wide area network (WAN) such as the Internet, a local area network (LAN), a cellular network, or any other type of network, as well as combinations of multiple networks. The network interface 114 of the depth imager 101 may comprise one or more conventional transceivers or other network interface circuitry configured to allow the depth imager 101 to communicate over network 104 with similar network interfaces in each of the processing devices 102.

The depth imager 101 in the present embodiment is generally configured to generate a first depth image using a first depth imaging technique, and to generate a second depth image using a second depth imaging technique different than the first depth imaging technique. At least portions of each of the first and second depth images are then merged to form a third depth image. At least one of the sensors 108 of the depth imager 101 is a single common sensor that is at least partially shared by the first and second depth imaging techniques, such that the first and second depth images are both generated at least in part using data acquired from the single common sensor.

By way of example, the first depth image may comprise an SL depth map generated using an SL depth imaging technique, and the second depth image may comprise a ToF depth map generated using a ToF depth imaging technique. Accordingly, the third depth image in such an embodiment merges SL and ToF depth maps generated using a single common sensor in a manner that results in higher quality depth information than would otherwise be obtained using the SL or ToF depth maps alone.

The first and second depth images may be generated at least in part using respective first and second different subsets of a plurality of sensor cells of the single common sensor. For example, the first depth image may be generated at least in part using a designated subset of a plurality of sensor cells of the single common sensor and the second depth image may be generated without using the sensor cells of the designated subset.

The particular configuration of image processing system 100 as shown in FIG. 1 is exemplary only, and the system 100 in other embodiments may include other elements in addition to or in place of those specifically shown, including one or more elements of a type commonly found in a conventional implementation of such a system.

Referring now to FIGS. 2 and 3, examples of the above-noted single common sensor 108 are shown.

The sensor 108 as illustrated in FIG. 2 comprises a plurality of sensor cells 200 arranged in the form of an array of sensor cells, including SL sensor cells and ToF sensor cells. More particularly, this 6×6 array example includes 4 SL sensor cells and 32 ToF sensor cells, although it should be understood that this arrangement is exemplary only and simplified for clarity of illustration. The particular number of sensors cells and array dimensions can be varied to accommodate the particular needs of a given application. Each sensor cell may also be referred to herein as a picture element or “pixel.” This term is also used to refer to elements of an image generated using the respective sensor cells.

FIG. 2 shows a total of 36 sensor cells, 4 of which are SL sensor cells and 32 of which are ToF sensor cells. More generally, approximately

$$\frac{1}{M}$$

of the total number of sensor cells are SL sensor cells and the remaining

$$\frac{M - 1}{M}$$

sensor cells are ToF sensor cells, where M is typically on the order of 9 but may take on other values in other embodiments.

It should be noted that the SL sensor cells and the ToF sensor cells may have different configurations. For example, each of the SL sensor cells may include a semiconductor photonic sensor that includes a direct current (DC) detector for processing unmodulated light in accordance with an SL depth imaging technique, while each of the ToF sensor cells may comprise a different type of photonic sensor that includes picosecond switches and high-precision integrating capacitors for processing radio frequency (RF) modulated light in accordance with a ToF depth imaging technique.

Alternatively, each of the sensor cells could be configured in substantially the same manner, with only the DC or RF output of a given such sensor cell being further processed depending on whether the sensor cell is used in SL or ToF depth imaging.

It is to be appreciated that the output light from a single emitter or multiple emitters in the present embodiment generally has both DC and RF components. In an exemplary SL depth imaging technique, the processing may utilize primarily the DC component as determined by integrating the return light over time to obtain a mean value. In an exemplary ToF depth imaging technique, the processing may utilize primarily the RF component in the form of phase shift values obtained from a synchronous RF demodulator. However, numerous other depth imaging arrangements are possible in other embodiments. For example, a ToF depth imaging technique may additionally employ the DC component, possibly for determining lighting conditions in phase measurement reliability estimation or for other purposes, depending on its particular set of features.

In the FIG. 2 embodiment, the SL sensor cells and the ToF sensor cells comprise respective first and second different subsets of the sensor cells 200 of the single common sensor 108. SL and ToF depth images are generated in this embodiment using these respective first and second different subsets of the sensor cells of the single common sensor. The different subsets are disjoint in this embodiment, such that the SL depth image is generated using only the SL cells and the ToF depth image is generated using only the ToF cells. This is an example of an arrangement in which a first depth image is generated at least in part using a designated subset of a plurality of sensor cells of the single common sensor and the second depth image is generated without using the sensor cells of the designated subset. In other embodiments, the subsets need not be disjoint. The FIG. 3 embodiment is an example of a sensor with different subsets of sensor cells that are not disjoint.

The sensor 108 as illustrated in FIG. 3 also comprises a plurality of sensor cells 200 arranged in the form of an array of sensor cells. However, in this embodiment, the sensor cells include ToF sensor cells as well as a number of joint SL and ToF (SL+ToF) sensor cells. More particularly, this 6×6 array example includes 4 SL+ToF sensor cells and 32 ToF sensor cells, although it should again be understood that this arrangement is exemplary only and simplified for clarity of illustration. The SL and ToF depth images are also generated in this embodiment using respective first and second different subsets of the sensor cells 200 of the single common sensor 108, but the SL+ToF sensor cells are used both for SL depth image generation and ToF depth image generation. Thus, the SL+ToF sensor cells are configured to produce both a DC output for use in subsequent SL depth image processing and an RF output for use in subsequent ToF depth image processing.

The embodiments of FIGS. 2 and 3 illustrate what is also referred to herein as “sensor fusion,” where a single common sensor 108 of the depth imager 101 is used to generate both SL and ToF depth images. Numerous alternative sensor fusion arrangements may be used in other embodiments.

The depth imager 101 may additionally or alternatively implement what is referred to herein as “emitter fusion,” where a single common emitter 106 of the depth imager 101 is used to generate output light for both SL and ToF depth imaging. Accordingly, the depth imager 101 may comprise a single common emitter 106 configured to generate output light in accordance with both an SL depth imaging technique and a ToF depth imaging technique. Alternatively, separate emitters may be used for different depth imaging techniques. For example, the depth imager 101 may comprise a first emitter 106 configured to generate output light in accordance with the SL depth imaging technique and a second emitter 106 configured to generate output light in accordance with the ToF depth imaging technique.

In an emitter fusion arrangement comprising a single common emitter, the single common emitter may be implemented, for example, using a masked integrated array of LEDs, lasers or other optical sources. Different SL and ToF optical sources can be interspersed in a checkerboard pattern in the single common emitter. Additionally or alternatively, RF modulation useful for ToF depth imaging may be applied to the SL optical sources of the single common emitter, in order to minimize offset bias that otherwise might arise when taking an RF output from a joint SL+ToF sensor cell.

It should be understood that sensor fusion and emitter fusion techniques as disclosed herein can be utilized in separate embodiments or both such techniques may be combined in a single embodiment. As will be described in more detail below in conjunction with FIGS. 4 through 6, use of one or more of these sensor and emitter fusion techniques in combination with appropriate data acquisition and depth map processing can result in higher quality depth images having enhanced depth resolution and fewer depth artifacts than those generated by conventional SL or ToF cameras.

The operation of data acquisition module 120 and depth map processing module 122 will now be described in greater detail with reference to FIGS. 4 through 6.

Referring initially to FIG. 4, a portion of the data acquisition module 120 associated with a particular semiconductor photonic sensor 108-(x,y) is shown as comprising elements 402, 404, 405, 406, 410, 412 and 414. Elements 402, 404, 406, 410, 412 and 414 are associated with a corresponding pixel, and element 405 represents information received from other pixels. It is assumed that all of these elements shown in FIG. 4 are replicated for each of the pixels of the single common sensor 108.

The photonic sensor 108-(x,y) represents at least a portion of a given one of the sensor cells 200 of the single common sensor 108 of FIG. 2 or 3, where x and y are respective indices of the rows and columns of the sensor cell matrix. The corresponding portion 120-(x,y) of the data acquisition module 120 comprises ToF demodulator 402, ToF reliability estimator 404, SL reliability estimator 406, ToF depth estimator 410, SL triangulation module 412 and depth decision module 414. The ToF demodulator is more specifically referred to in the context of this embodiment as a “ToF-like demodulator” as it may comprise a demodulator adapted to perform ToF functionality.

The SL triangulation module 412 is illustratively implemented using a combination of hardware and software, and the depth decision module 414 is illustratively implemented using a combination of hardware and firmware, although other arrangements of one or more of hardware, software and firmware may be used to implement these modules as well as other modules or components disclosed herein.

In the figure, IR light returned from a scene being imaged is detected in the photonic sensor 108-(x,y). This yields input information Aᵢ(x,y) which is applied to the ToF demodulator 402. The input information Aᵢ(x,y) comprises amplitude information A(x,y) and intensity information B(x,y).

The ToF demodulator 402 demodulates the amplitude information A(x,y) to generate phase information φ(x,y) that is provided to the ToF depth estimator 410, which generates a ToF depth estimate using the phase information. The ToF demodulator 402 also provides the amplitude information A(x,y) to the ToF reliability estimator 404, and the intensity information B(x,y) to the SL reliability estimator 406. The ToF reliability estimator 404 generates a ToF reliability estimate using the amplitude information, and the SL reliability estimator 406 generates an SL reliability estimate using the intensity information.

The SL reliability estimator 406 also generates estimated SL intensity information Ĩ_{SL}(x, y) using the intensity information B(x,y). The estimated SL intensity information Ĩ_{SL}(x, y) is provided to the SL triangulation module 412 for use in generating the SL depth estimate.

In this embodiment, the estimated SL intensity information Ĩ_{SL}(x, y) is used in place of the intensity information B(x,y) because the latter includes not only the reflected light I_{SL} from an SL pattern or portion thereof that is useful to reconstruct depth via triangulation, but also undesirable terms including possibly a DC offset component I_{offset} from a ToF emitter and a backlight component I_{backlight} from other ambient IR sources. Accordingly, the intensity information B(x,y) can be expressed as follows:

B(x,y)=I_{SL}(x,y)+I_{offset}(x,y)+I_{backlight}(x,y).

The second and third terms of B(x,y) representing the respective undesirable offset and backlight components are relatively constant in time and uniform in the x-y plane. These components can therefore be substantially removed by subtracting their mean over all possible (x,y) values as follows:

$${\tilde{I}}_{SL} ( x , y ) = B ( x , y ) - \frac{1}{XY} {\sum }_{x = 1}^{X} {\sum }_{y = 1}^{Y} B ( x , y ) .$$

Any remaining variations of Ĩ_{SL}(x, y) attributable to the undesirable offset and backlight components will not severely impact the depth measurements because triangulation involves pixel positions rather than pixel intensities. The estimated SL intensity information Ĩ_{SL}(x, y) is passed to the SL triangulation module 412.

Numerous other techniques can be used to generate the estimated SL intensity information Ĩ_{SL}(x, y) from the intensity information B(x,y). For example, in another embodiment, the magnitude of a smoothed squared spatial gradient estimate G(x,y) in the x-y plane is evaluated to identify those (x,y) positions that are most adversely impacted by the undesired components:

G(x,y)=smoothing_filter((B(x,y)−B(x+1,y+1))²+(B(x+1,y)−B(x,y+))²).

In this example, the smoothed squared spatial gradient G(x,y) serves as an auxiliary mask for identifying impacted pixel positions such that:

(x_{SL},y_{SL})=argmax(B(x,y)·G(x,y)).

where the pairs (x_{SL},y_{SL}) give coordinates of the impacted pixel positions. Again, other techniques can be used to generate Ĩ_{SL}(x, y).

The depth decision module 414 receives the ToF depth estimate from ToF depth estimator 410 and the SL depth estimate, if any, for the given pixel, from the SL triangulation module 412. It also receives the ToF and SL reliability estimates from the respective reliability estimators 404 and 406. The depth decision module 414 utilizes the ToF and SL depth estimates and the corresponding reliability estimators to generate a local depth estimate for the given sensor cell.

As one example, the depth decision module 414 can balance the SL and ToF depth estimates to minimize resulting uncertainty by taking a weighted sum:

Dᵣₑₛᵤₗₜ(x,y)=(D_{ToF}(x,y)·Rel_{ToF}(x,y)+D_{SL}(x,y)·Rel_{SL}(x,y))/(Rel_{ToF}(x,y)+Rel_{SL}(x,y))

where D_{SL} and D_{ToF} denote the respective SL and ToF depth estimates, Rel_{SL} and Rel_{ToF} denote the respective SL and ToF reliability estimates, and Dᵣₑₛᵤₗₜ denotes the local depth estimate generated by the depth decision module 414.

The reliability estimates used in the present embodiment can take into account differences between SL and ToF depth imaging performance as a function of range to an imaged object. For example, in some implementations, SL depth imaging may perform better than ToF depth imaging at short and intermediate ranges, while ToF depth imaging may perform better than SL depth imaging at longer ranges. Such information as reflected in the reliability estimates can provide further improvement in the resulting local depth estimate.

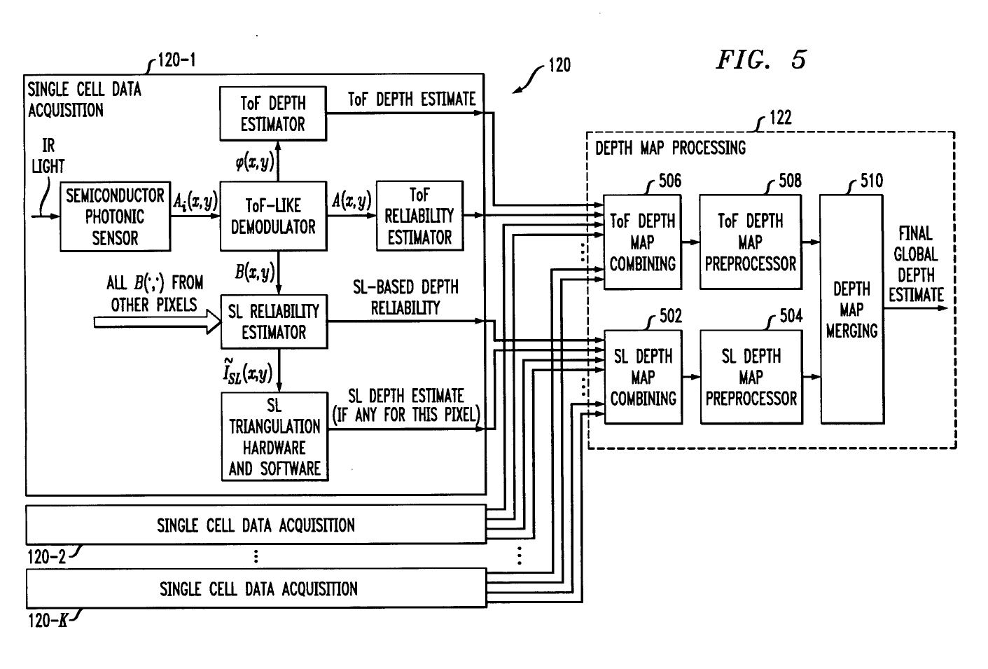

In the FIG. 4 embodiment, local depth estimates are generated for each cell or pixel of the sensor array. However, in other embodiments, global depth estimates may be generated over groups of multiple cells or pixels, as will now be described in conjunction with FIG. 5. More particularly, in the FIG. 5 arrangement, a global depth estimate is generated for a given cell and one or more additional cells of the single common sensor 108 based on the SL and ToF depth estimates and corresponding SL and ToF reliability estimates as determined for the given cell and similarly determined for the one or more additional cells.

It should also be noted that hybrid arrangements may be used, involving a combination of local depth estimates generated as illustrated in FIG. 4 and global depth estimates generated as illustrated in FIG. 5. For example, global reconstruction of depth information may be utilized when local reconstruction of depth information is not possible due to the absence of reliable depth data from both SL and ToF sources or for other reasons.

In the FIG. 5 embodiment, depth map processing module 120 generates a global depth estimate over a set of K sensor cells or pixels. The data acquisition module 120 comprises K instances of a single cell data acquisition module that corresponds generally to the FIG. 4 arrangement but without the local depth decision module 414. Each of the instances 120-1, 120-2, . . . 120-K of the single cell data acquisition module has an associated photonic sensor 108-(x,y) as well as demodulator 402, reliability estimators 404 and 406, ToF depth estimator 410 and SL triangulation module 410. Accordingly, each of the single cell data acquisition modules 120 shown in FIG. 5 is configured substantially as illustrated in FIG. 4, with the difference being that the local depth decision module 414 is eliminated from each module.

The FIG. 5 embodiment thus aggregates the single cell data acquisition modules 120 into a depth map merging framework. The elements 405 associated with at least a subset of the respective modules 120 may be combined with the intensity signal lines from the corresponding ToF demodulators 402 of those modules in order to form a grid carrying a specified set of intensity information B(.,.) for a designated neighborhood. In such an arrangement, each of the ToF demodulators 402 in the designated neighborhood provides its intensity information B(x,y) to the combined grid in order to facilitate distribution of such intensity information among the neighboring modules. As one example, a neighborhood of size (2M+1)×(2M+1) may be defined, with the grid carrying intensity values B(x−M,y−M) . . . B(x+M,y−M), . . . , B(x−M,y+M) . . . B(x+M,y+M) that are supplied to the SL reliability estimators 406 in the corresponding modules 120.

The K sensor cells illustrated in the FIG. 5 embodiment may comprise all of the sensor cells 200 of the single common sensor 108, or a particular group comprising fewer than all of the sensor cells. In the latter case, the FIG. 5 arrangement may be replicated for multiple groups of sensor cells in order to provide global depth estimates covering all of the sensor cells of the single common sensor 108.

The depth map processing module 122 in this embodiment further comprises SL depth map combining module 502, SL depth map preprocessor 504, ToF depth map combining module 506, ToF depth map preprocessor 508, and depth map merging module 510.

The SL depth map combining module 502 receives SL depth estimates and associated SL reliability estimates from the respective SL triangulation modules 412 and SL reliability estimators 406 in the respective single cell data acquisition modules 120-1 through 120-K, and generates an SL depth map using this received information.

Similarly, the ToF depth map combining module 506 receives ToF depth estimates and associated ToF reliability estimates from the respective ToF depth estimators 410 and ToF reliability estimators 404 in the respective single cell data acquisition modules 120-1 through 120-K, and generates a ToF depth map using this received information.

At least one of the SL depth map from combining module 502 and the ToF depth map from combining module 506 is further processed in its associated preprocessor 504 or 508 so as to substantially equalize the resolutions of the respective depth maps. The substantially equalized SL and ToF depth maps are then merged in depth map merging module 520 in order to provide a final global depth estimate. The final global depth estimate may be in the form of a merged depth map.

For example, in the single common sensor embodiment of FIG. 2, SL depth information is potentially obtainable from approximately

$$\frac{1}{M}$$

of the total number of sensor cells 200 and ToF depth information is potentially obtainable from the remaining

$$\frac{M - 1}{M}$$

sensor cells. The FIG. 3 sensor embodiment is similar, but ToF depth information is potentially obtainable from all of the sensor cells. As indicated previously, ToF depth imaging techniques generally provide better x-y resolution than SL depth imaging techniques, while SL depth imaging techniques generally provide better z resolution than ToF cameras. Accordingly, in an arrangement of this type, the merged depth map combines the relatively more accurate SL depth information with the relatively less accurate ToF depth information, while also combining the relatively more accurate ToF x-y information with the relatively less accurate SL x-y information, and therefore exhibits enhanced resolution in all dimensions and fewer depth artifacts than a depth map produced using only SL or ToF depth imaging techniques.

In the SL depth map combining module 502, the SL depth estimates and corresponding SL reliability estimates from the single cell data acquisition modules 120-1 through 120-K may be processed in the following manner. Let D₀ denote SL depth imaging information comprising a set of (x,y,z) triples where (x,y) denotes the position of an SL sensor cell and z is the depth value at position (x,y) obtained using SL triangulation. The set D₀ can be formed in SL depth map combining module 502 using a threshold-based decision rule:

D₀={(x,y,D_{SL}(x,y)):Rel_{SL}(x,y)>Threshold_{SL}}.

As one example, Rel_{SL}(x,y) can be a binary reliability estimate equal to 0 if the corresponding depth information is missing and 1 if it is present, and in such an arrangement Threshold_{SL} can be equal to an intermediate value such as 0.5. Numerous alternative reliability estimates, threshold values and threshold-based decision rules may be used. Based on D₀, an SL depth map comprising a sparse matrix D₁ is constructed in combining module 502, with the sparse matrix D₁ containing z values in corresponding (x,y) positions and zeros in all other positions.

In the ToF depth map combining module 506, a similar approach may be used. Accordingly, the ToF depth estimates and corresponding ToF reliability estimates from the single cell data acquisition modules 120-1 through 120-K may be processed in the following manner. Let T₀ denote ToF depth imaging information comprising a set of (x,y,z) triples where (x,y) denotes the position of a ToF sensor cell and z is the depth value at position (x,y) obtained using ToF phase information. The set T₀ can be formed in ToF depth map combining module 506 using a threshold-based decision rule:

T₀={(x,y,D_{ToF}(x,y)):Rel_{ToF}(x,y)>Threshold_{ToF}}.

As in the SL case described previously, a variety of different types of reliability estimates Rel_{ToF}(x,y) and thresholds Threshold_{ToF} can be used. Based on T₀, a ToF depth map comprising a matrix T₁ is constructed in combining module 506, with the matrix T₁ containing z values in corresponding (x,y) positions and zeros in all other positions.

Assuming use of a single common sensor 108 with sensor cells arranged as illustrated in FIG. 2 or FIG. 3, the number of ToF sensor cells is much greater than the number of SL sensor cells, and therefore the matrix T₁ is not a sparse matrix like the matrix D₁. Since there are fewer zero values in T₁ than in D₁, T₁ is subject to interpolation-based reconstruction in preprocessor 508 before the ToF and SL depth maps are merged in the depth map merging module 510. This preprocessing more particularly involves reconstructing depth values for those positions that contain zeros in T₁.

The interpolation in the present embodiment involves identifying a particular pixel having a zero in its position in T₁, identifying a neighborhood of pixels for the particular pixel, and interpolating a depth value for the particular pixel based on depth values of the respective pixels in the neighborhood of pixels. This process is repeated for each of the zero depth value pixels in T₁.

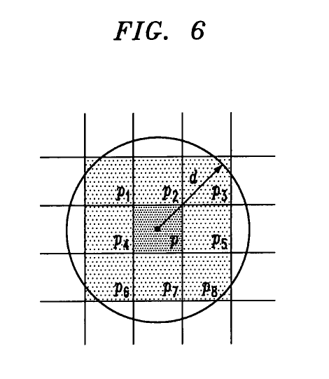

FIG. 6 shows a pixel neighborhood around a zero depth value pixel in the ToF depth map matrix T₁. In this embodiment, the pixel neighborhood comprises eight pixels p₁ through p₈ surrounding a particular pixel p.

By way of example, the neighborhood of pixels for the particular pixel p illustratively comprises a set Sₚ of n neighbors of pixel p:

Sₚ={p₁ . . . pₙ},

where the n neighbors each satisfy the inequality:

∥p−p₁∥<d,

where d is a threshold or neighborhood radius and ∥.∥ denotes Euclidian distance between pixels p and pᵢ in the x-y plane, as measured between their respective centers. Although Euclidean distance is used in this example, other types of distance metrics may be used, such as a Manhattan distance metric, or more generally a p-norm distance metric. An example of d corresponding to a radius of a circle is illustrated in FIG. 6 for the eight-pixel neighborhood of pixel p. It should be understood, however, that numerous other techniques may be used to identify pixel neighborhoods for respective particular pixels.

For the particular pixel p having the pixel neighborhood shown in FIG. 6, the depth value zₚ for that pixel can be computed as the mean of the depth values of the respective neighboring pixels:

$${z}_{p} = \frac{1}{n} {\sum }_{i = 1}^{n} {z}_{i} ,$$

or as the median of the depth values of the respective neighboring pixels:

zₚ=medianᵢ₌₁ⁿ(z).

It is to be appreciated that the mean and median used above are just examples of two possible interpolation techniques that may be applied in embodiments of the invention, and numerous other interpolation techniques known to those skilled in the art may be used in place of mean or median interpolation.

The SL depth map D₁ from the SL depth map combining module 502 can also be subject to one or more preprocessing operation, in SL depth map preprocessor 504. For example, interpolation techniques of the type described above for ToF depth map T₁ may also be applied to SL depth map D₁ in some embodiments.

As another example of SL depth map preprocessing, assume that SL depth map D₁ has a resolution of M_{D}×N_{D} pixels corresponding to the desired size of the merged depth map and ToF depth map T₁ from the ToF depth map combining module 506 has a resolution of M_{ToF}×N_{ToF} pixels, where M_{ToF}≦M_{D} and N_{ToF}≦N_{D}. In this case, the ToF depth map resolution may be increased to substantially match that of the SL depth map using any of a number of well-known image upsampling techniques, including upsampling techniques based on bilinear or cubic interpolation. Cropping of one or both of the SL and ToF depth maps may be applied before or after depth map resizing if necessary in order to maintain a desired aspect ratio. Such upsampling and cropping operations are examples of what are more generally referred to herein as depth image preprocessing operations.

The depth map merging module 510 in the present embodiment receives a preprocessed SL depth map and a preprocessed ToF depth map, both of substantially equal size or resolution. For example, the ToF depth map after upsampling as previously described has the desired merged depth map resolution of M_{D}×N_{D} and no pixels with missing depth values, while the SL depth map has the same resolution but may have some pixels with missing depth values. These two SL and ToF depth maps may then be merged in module 510 using the following exemplary process:

1. For each pixel (x,y) in SL depth map D₁, estimate a standard depth deviation σ_{D}(x,y) based on a fixed pixel neighborhood of (x,y) in D₁.

2. For each pixel (x,y) in ToF depth map T₁, estimate a standard depth deviation σ_{T}(x,y) based on a fixed pixel neighborhood of (x,y) in T₁.

3. Merge the SL and ToF depth maps using standard deviation minimization approach:

$$z ( x , y ) = \{ \begin{matrix}{D}_{1} ( x , y ) , if {σ}_{D} ( x , y ) < {σ}_{T} ( x , y ) \\ {T}_{1} ( x , y ) , otherwise\end{matrix}$$

An alternative approach is to apply a super resolution technique, possibly based on Markov random fields. Embodiments of an approach of this type are described in greater detail in Russian Patent Application Attorney Docket No. L12-1346RU1, entitled “Image Processing Method and Apparatus for Elimination of Depth Artifacts,” which is commonly assigned herewith and incorporated by reference herein, and can allow depth artifacts in a depth map or other type of depth image to be substantially eliminated or otherwise reduced in a particularly efficient manner. The super resolution technique in one such embodiment is used to reconstruct depth information of one or more potentially defective pixels. Additional details regarding super resolution techniques that may be adapted for use in embodiments of the invention can be found in, for example, J. Diebel et al., “An Application of Markov Random Fields to Range Sensing,” NIPS, MIT Press, pp. 291-298, 2005, and Q. Yang et al., “Spatial-Depth Super Resolution for Range Images,” IEEE Conference on Computer Vision and Pattern Recognition (CVPR), 2007, both of which are incorporated by reference herein. However, the above are just examples of super resolution techniques that may be used in embodiments of the invention. The term “super resolution technique” as used herein is intended to be broadly construed so as to encompass techniques that can be used to enhance the resolution of a given image, possibly by using one or more other images.

It should be noted that calibration may be used in some embodiments. For example, in an embodiment in which two separate sensors 108 are utilized to generate respective SL and ToF depth maps, the two sensors may be fixed in location relative to one another and then calibrated in the following manner.

First, SL and ToF depth images are obtained using the respective sensors. Multiple corresponding points are located in the images, usually at least four such points. Denote m as the number of such points, and define D_{xyz} as a 3×m matrix containing the x, y and z coordinates for each of the m points from the SL depth image and T_{xyz} as a 3×m matrix containing the x, y and z coordinates for each of the corresponding m points from the ToF depth image. Denote A and TR as an affine transform matrix and a translation vector, respectively, determined as optimal in a least mean squares sense, where:

T_{xyz}=A·D_{xyz}+TR.

The matrix A and vector TR can be found as a solution of the following optimization problem:

R=∥A·D_{xyz}+TR−T_{xyz}∥²→min.

Using element-wise notation, A={aᵢⱼ}, where (i,j)=(1,1) . . . (3,3), and TR={trₖ}, where k=1, . . . 3. The solution of this optimization problem in the least mean squares sense is based on the following system of linear equations that includes 12 variables and 12m equations:

dR/daᵢⱼ=0, i=1,2,3, j=1,2,3,

dR/dtrₖ=0, k=1,2,3.

The next calibration step is to transform the SL depth map D₁ into the coordinate system of the ToF depth map T₁. This can be done using the already known A and TR affine transform parameters as follows:

D_{1xyz}=A·D_{xyz}+TR.

The resulting (x,y) coordinates of pixels in D_{1xyz} are not always integers, but are more generally rational numbers. Accordingly, those rational number coordinates can be mapped to a regular grid comprising equidistant orthogonal integer lattice points of the ToF image T₁ having resolution M_{D}×N_{D}, possibly using interpolation based on nearest neighbors or other techniques. After such a mapping, some points in the regular grid may remain unfilled, but this resulting lacunal lattice is not crucial for application of a super resolution technique. Such a super resolution technique may be applied to obtain an SL depth map D₂ having resolution M_{D}×N_{D} and possibly with one or more zero depth pixel positions.

A variety of alternative calibration processes may be used. Also, calibration need not be applied in other embodiments.

It should again be emphasized that the embodiments of the invention as described herein are intended to be illustrative only. For example, other embodiments of the invention can be implemented utilizing a wide variety of different types and arrangements of image processing systems, depth imagers, depth imaging techniques, sensor configurations, data acquisition modules and depth map processing modules than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

What is claimed is:

1. A method comprising:
generating a first depth image using a first depth imaging technique;
generating a second depth image using a second depth imaging technique different than the first depth imaging technique; and
merging at least portions of the first and second depth images to form a third depth image;
wherein the first and second depth images are both generated at least in part using data acquired from a single common sensor of a depth imager.

2. The method of claim 1 wherein the first depth image comprises a structured light depth map generated using a structured light depth imaging technique, and the second depth image comprises a time of flight depth map generated using a time of flight depth imaging technique.

3. The method of claim 1 wherein the first and second depth images are generated at least in part using respective first and second different subsets of a plurality of sensor cells of the single common sensor.

4. The method of claim 1 wherein the first depth image is generated at least in part using a designated subset of a plurality of sensor cells of the single common sensor and the second depth image is generated without using the sensor cells of the designated subset.

5. The method of claim 2 wherein generating the first and second depth images comprises, for a given cell of the common sensor:
receiving amplitude information from the given cell;
demodulating the amplitude information to generate phase information;
generating a time of flight depth estimate using the phase information;
generating a time of flight reliability estimate using the amplitude information;
receiving intensity information from the given cell;
generating a structured light depth estimate using the intensity information; and
generating a structured light reliability estimate using the intensity information.

6. The method of claim 5 further comprising generating a local depth estimate for the given cell based on the time of flight and structured light depth estimates and the corresponding time of flight and structured light reliability estimates.

7. The method of claim 5 wherein generating the structured light depth estimate and the corresponding structured light reliability estimate comprises:
generating estimated structured light intensity information using the intensity information;
generating the structured light depth estimate using the estimated structured light intensity information; and
generating the structured light reliability estimate using the intensity information.

8. The method of claim 5 further comprising generating a global depth estimate for the given cell and one or more additional cells of the sensor based on the time of flight and structured light depth estimates and the corresponding time of flight and structured light reliability estimates as determined for the given cell and similarly determined for the one or more additional cells.

9. The method of claim 2 wherein generating the first and second depth images comprises:
generating the structured light depth map as a combination of structured light depth information obtained using a first plurality of cells of the common sensor;
generating the time of flight depth map as a combination of time of flight depth information obtained using a second plurality of cells of the common sensor;
preprocessing at least one of the structured light depth map and the time of flight depth map so as to substantially equalize their respective resolutions; and
merging the substantially equalized structured light depth map and the time of flight depth map to generate a merged depth map.

10. The method of claim 9 wherein said preprocessing comprises:
identifying a particular pixel in the corresponding depth map;
identifying a neighborhood of pixels for the particular pixel; and
interpolating a depth value for the particular pixel based on depth values of the respective pixels in the neighborhood of pixels.

11. A computer-readable storage medium having computer program code embodied therein, wherein the computer program code when executed in an image processing system comprising the depth imager causes the image processing system to perform the method as recited in claim 1.

12. An apparatus comprising:
a depth imager comprising at least one sensor;
wherein the depth imager is configured to generate a first depth image using a first depth imaging technique, and to generate a second depth image using a second depth imaging technique different than the first depth imaging technique;
wherein at least portions of each of the first and second depth images are merged to form a third depth image; and
wherein said at least one sensor comprises a single common sensor at least partially shared by the first and second depth imaging techniques such that the first and second depth images are both generated at least in part using data acquired from the single common sensor.

13. The apparatus of claim 12 wherein the first depth image comprises a structured light depth map generated using a structured light depth imaging technique, and the second depth image comprises a time of flight depth map generated using a time of flight depth imaging technique.

14. The apparatus of claim 12 wherein the depth imager further comprises a first emitter configured to generate output light in accordance with a structured light depth imaging technique and a second emitter configured to generate output light in accordance with a time of flight depth imaging technique.

15. The apparatus of claim 12 wherein the depth imager comprises at least one emitter wherein said at least one emitter comprises a single common emitter configured to generate output light in accordance with both a structured light depth imaging technique and a time of flight depth imaging technique.

16. The apparatus of claim 12 wherein the depth imager is configured to generate the first and second depth images at least in part using respective first and second different subsets of a plurality of sensor cells of the single common sensor.

17. The apparatus of claim 12 wherein the depth imager is configured to generate the first depth image at least in part using a designated subset of a plurality of sensor cells of the single common sensor and to generate the second depth image without using the sensor cells of the designated subset.

18. The apparatus of claim 12 wherein the single common sensor comprises a plurality of structured light sensor cells and a plurality of time of flight sensor cells.

19. The apparatus of claim 12 wherein the single common sensor comprises at least one sensor cell that is a joint structured light and time of flight sensor cell.

20. An image processing system comprising:
at least one processing device; and
a depth imager associated with the processing device and comprising at least one sensor;
wherein the depth imager is configured to generate a first depth image using a first depth imaging technique, and to generate a second depth image using a second depth imaging technique different than the first depth imaging technique;
wherein at least portions of each of the first and second depth images are merged to form a third depth image; and
wherein said at least one sensor comprises a single common sensor at least partially shared by the first and second depth imaging techniques such that the first and second depth images are both generated at least in part using data acquired from the single common sensor.

21. A gesture detection system comprising the image processing system of claim 20.
